(19) United States
(12) Patent Application Publication
(10) Pub. No.: US 2014/0023850 A1
(43) Pub. Date: Jan. 23, 2014

(54) PROTECTIVE FIRE-RESISTANT COATING AND APPLICATION METHOD

(71) Applicant: Bernard Marquez, Neyron (FR)

(72) Inventor: Bernard Marquez, Neyron (FR)

(73) Assignee: SOLETANCHE FREYSSINET, Rueil Malmaison (FR)

(21) Appl. No.: 14/008,515

(22) PCT Filed: Jul. 18, 2011
(86) PCT No.: PCT/FR2011/051718

§ 371 Date: Sep. 27, 2013

(30) Foreign Application Priority Data
Apr. 1, 2011 (FR) 11 52802

(51) Int. Cl. A62C 2/06

(52) U.S. Cl. CPC A62C 2/06
USPC 428/317.1; 156/60

(57) ABSTRACT

The protective fire-resistant coating comprises a plurality of stacked fibrous layers (1, 2) and a layer of refractory glue (4) placed between two of the fibrous layers. The glue comprises active elements which can release water during an increase in temperature. In at least one layer of refractory glue, a vapour-permeable substrate (5) that is impregnated with the refractory glue extends parallel to the fibrous layers.

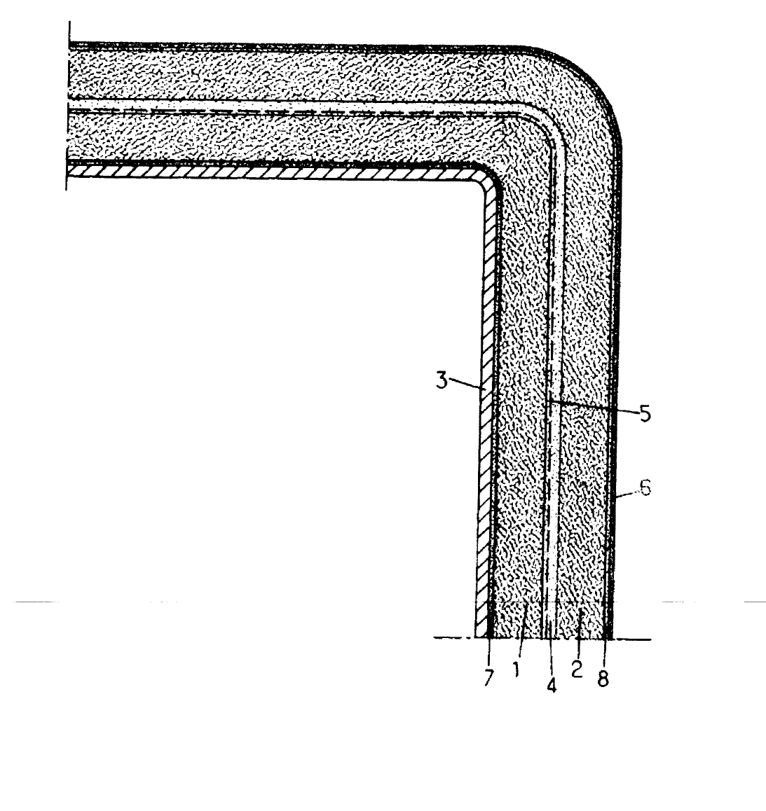

The invention relates to techniques for protecting installations against fire.

There is a distinction between active protection techniques, in which detectors are used to detect fire conditions in order to trigger a response by active elements, and passive protection techniques to which the present invention more particularly pertains.

Fire-resistant coatings are used to implement passive protection techniques. One coating of interest is the subject of patent EP 0 612 540. It consists of a flexible coating comprising a complex of fibrous and/or textile elements, e.g. based on mineral wool, assembled by gluing. The glue used is a refractory glue which withstands temperatures of up to 1300° C. and incorporates active components or additives containing chemically bound water and stable at temperatures below 80° C. Aluminosilicates are typically used in glues of this type.

A passive coating delays the propagation of heat between a hot side reachable by an accidental fire, and a cold side facing the protected installation. The delaying effect is mostly due to the release of water molecules by the glue when the temperature rises. The water absorbs heat by evaporation, which results in a plateau at 100° C. in the graph of the temperature increase of the cold side over time.

It is of course desirable to increase the duration of this 100° C. plateau by increasing the amount of glue incorporated into the passive element. Several methods are possible for this:
increasing the glue density. It then runs the risk of becoming too thick and very difficult to use in the application of a flexible coating. This difficulty is further increased by the reduced drying time that results from thickening the glue. In addition, overly dense glue can damage the mineral wool when it is spread;
increasing the amount of glue between two fibrous layers. In this case, the glue tends to run when it is applied and before it dries. This solution does not guarantee that the fire-resistance is properly distributed;
increasing the number of layers of mineral wool and of glue between them. The disadvantage is that this noticeably increases the volume occupied by the coating.

One important field in which passive coatings of this type are used, although not the only field, is in fire-resistant protection for industrial facilities requiring high levels of safety. In particular, they are commonly used to protect cable raceways or other electrical equipment in nuclear power plants. As safety requirements are continuously increasing, particularly in such plants, there is a need to improve the performance of fire-resistant coatings.

Due to growing safety constraints, there is increasing redundancy in the electrical systems, particularly the cables. There may be up to four levels of redundancy in the cable lines, instead of the two levels in previous generations of plants. A larger number of cable raceways must therefore be protected, which means that solutions where the coating occupies too much space are unacceptable. It would be desirable to obtain better performance from these coatings while making them more compact.

An object of the invention is to satisfy at least some of the needs described above.

A fire-resistant coating is therefore proposed, comprising:
a plurality of stacked fibrous layers; and
at least one refractory glue layer placed between two of the fibrous layers, said glue comprising active elements capable of releasing water upon a temperature increase; and
in at least one refractory glue layer, a vapor-permeable support member extending parallel to the fibrous layers and impregnated with the refractory glue.

The vapor-permeable support member retains the refractory glue, preventing it from running during the application phase. In case of fire, it does not interfere with the release of vaporized water, which improves the effectiveness of the coating by offering better penetration into the fibrous layers regardless of their density.

It is thus possible to increase the density of the fibrous layers, specifically to more than 140 kg/m³. A preferred density value is substantially 150 kg/m³.

These higher-density fibrous layers can offer a reduced thickness of less than 30 mm, compared to the thicknesses commonly used in the past which were about 38 mm. These arrangements advantageously allow reducing the volume occupied by the protective fire-resistant coating without sacrificing performance.

The vapor-permeable support member facilitates the impregnation with glue, which avoids damage to the fibrous layers. It is preferably made of non-combustible material (Euroclass A1), which may include a cloth of refractory fibers, typically fiberglass cloth.

Another aspect of the invention relates to a method for applying a protective fire-resistant coating, comprising:
placing a first fibrous layer, possibly glued with refractory glue, onto an element to be protected;
applying a refractory glue layer onto the first fibrous layer, said refractory glue layer incorporating a vapor-permeable support member extending parallel to the first fibrous layer and impregnated with the refractory glue; and
placing at least a second fibrous layer over the refractory glue layer.

In one useful implementation, the vapor-permeable support member is glued onto the first fibrous layer before the first fibrous layer is placed onto the element to be protected. The support member then contributes to the cohesion of the first fibrous layer during its placement onto the element to be protected. This reduces the risk of the fibrous layer tearing, particularly in areas where it has to follow a relatively pronounced bend.

Other features and advantages of the invention will become apparent form the following description of an example of a non-limiting embodiment, with reference to the accompanying drawing in which the sole FIGURE shows a cross-section of a protective fire-resistant coating according to an embodiment of the invention.

In the example embodiment represented in the FIGURE, the protective fire-resistant coating contains two stacked fibrous layers 1, 2, based on felted mineral wool or other appropriate fibrous refractory material. It is known that such fibrous layers 1, 2 may possibly contain particles which contribute to slowing the propagation of heat.

These fibrous layers 1, 2 cover an element 3 to be protected from fire, such as for example a cable raceway or pipes, a switch box or electrical cabinet, control mechanisms, transmission mechanisms, etc.

A refractory glue is incorporated into the fire-resistant coating, in particular in the form of a layer 4 placed between the two fibrous layers 1, 2. As is usual in this type of coating, the glue used includes active elements which release water when the temperature increases, for example to above 80° C. By vaporizing at 100° C., this water slows the propagation of heat from the external side (hot side) of the coating towards its internal side (cold side). A so-called F.active glue may be used, which is based on metal oxide hydrates.

A vapor-permeable two-dimensional support member 5 lies within the refractory glue layer 4. An appropriate material for this support member 5 is fiberglass cloth, as such cloth is relatively cheap while offering the desired properties, especially a high capacity for impregnation with the refractory glue and a high capacity for diffusing the water vapor released when the coating temperature rises. It is also a non-combustible material (Euroclass A1), which therefore does not contribute to the fire if one occurs.

The cloth 5 is impregnated and retains the refractory glue during its application, which ensures there is satisfactory distribution of the glue over the entire coating. It thus allows increasing the amount of glue placed between the fibrous layers 1, 2, and therefore improves the performance of the fire-resistant coating.

The vapor-permeable support member 5 tends to prevent irregularities in the distribution of the refractory glue, particularly in areas where the layer 4 is disposed vertically. This function is performed during application of the coating, but also later on once the glue has set, as the coating may be subject to vibrations.

As is conventional, the fire-resistant coating may have an external envelope 6 which renders it fluid-tight. This envelope 6 is made, for example, of mineral fiber cloth impregnated with a fire-retardant elastomer.

The application of the fire-resistant coating onto an element to be protected 3 can be performed, for example, as follows.

Firstly, the first fibrous layer 1 is spread out on the ground or some other work surface, and F.active glue is applied onto its external face followed by the fiberglass cloth 5 which is allowed to become impregnated with the glue.

F.active glue, or some other appropriate glue, 7 is applied to the element 3, then the first fibrous layer 1 is placed on it.

After placement of this first fibrous layer 1, F.active glue is again spread on the external face to complete the layer 4, then the second fibrous layer 2 is placed over the refractory glue layer 4. If necessary, ropes or cords can be placed around the fibrous layer to retain the assembly.

Lastly, the fluid-tight envelope 6 is glued onto the second fibrous layer 2 using an appropriate glue 8.

If it is necessary to provide more than two fibrous layers 1, 2, the layers can be successively put in place, with each layer except the last having fiberglass cloth 5 pre-glued to its external face.

It is also possible to place the fiberglass cloth 5 onto the fibrous layer 1 after the layer has been glued onto the element 3 to be protected. However, it is preferable to apply the cloth 5 onto the fibrous layer 1 prior to its installation, as the pre-glued cloth reduces the risk of tearing the fibrous layer 1.

Another aspect of the invention, facilitated by the presence of the vapor-permeable support member 5, relates to an increase in the density of the fibrous layers 1, 2. This density can exceed 140 kg/m³. The value of the density can be 160 kg/m³ for example, or in an appropriate compromise can be approximately 150 kg/m³.

By thus increasing the density of the mineral wool employed, the thickness of the layers 1, 2 can be reduced while maintaining comparable performance, thus limiting the volume occupied by the coating.

In particular, the thickness of the fibrous layers 1, 2 can be less than 30 mm. One possible value for this thickness is 25 mm. If the use of fibrous layers 1, 2 having a density of 150 kg/m³ and a thickness of 25 mm is compared to the use of conventional layers having a density of 125 kg/m³ and a thickness of 38 mm, it can be seen that the thickness of each layer is reduced by 34.2%, while the total weight of the mineral wool in the fire-resistant coating is reduced by 21.1%. The envisioned dimensioning is also advantageous in terms of weight, which is of course desirable, including when considering requirements to be met concerning earthquakes.

The embodiments described or mentioned above are illustrations of the present invention. Various changes can be made to them without leaving the scope of the invention as set forth in the attached claims.

1. A protective fire-resistant coating, comprising:
a plurality of stacked fibrous layers; and
at least one refractory glue layer of placed between two of the fibrous layers, said glue comprising active elements capable of releasing water upon a temperature increase; and
in at least one refractory glue layer, a vapor-permeable support member extending parallel to the fibrous layers and impregnated with the refractory glue.

2. The protective fire-resistant coating of claim 1, wherein the vapor-permeable support member is of non-combustible material.

3. The protective fire-resistant coating of claim 2, wherein the vapor-permeable support member comprises a cloth of refractory fibers.

4. The protective fire-resistant coating of claim 3, wherein the cloth of refractory fiber is fiberglass cloth.

5. The protective fire-resistant coating of claim 1, wherein at least some of the fibrous layers have a density greater than 140 kg/m³.

6. The protective fire-resistant coating of claim 5, wherein the density of said fibrous layers is substantially 150 kg/m³.

7. The protective fire-resistant coating of claim 5 or 6, wherein the fibrous layers of a density greater than 140 kg/m³ have a thickness of less than 30 mm.

8. A method for applying a protective fire-resistant coating, comprising:
placing a first fibrous layer onto an element to be protected;
applying a refractory glue layer onto the first fibrous layer, said refractory glue layer comprising active elements capable of releasing water upon a temperature increase and incorporating a vapor-permeable support member extending parallel to the first fibrous layer and impregnated with the refractory glue; and
placing at least a second fibrous layer over the refractory glue layer.

9. The method of claim 8, wherein the vapor-permeable support member is glued onto the first fibrous layer before the first fibrous layer is placed onto the element to be protected.

10. The method of claim 8, wherein the vapor-permeable support member comprises fiberglass cloth.

11. The method of claim 8, wherein the first and second fibrous layers each have a density greater than 140 kg/m³ and a thickness of less than 30 mm.
